(19) United States
(12) Patent Application Publication
(10) Pub. No.: US 2008/0222105 A1
(43) Pub. Date: Sep. 11, 2008

(54) Entity recommendation system using restricted information tagged to selected entities

(76) Inventor: Joseph Matheny, Santa Barbara, CA (US)

Correspondence Address: Ralph A. Dowell of DOWELL & DOWELL P.C., 2111 Eisenhower Ave, Suite 406, Alexandria, VA, 22314, US

(21) Appl. No.: 11/716,012

(22) Filed: Mar. 9, 2007

(51) Int. Cl. G06F 17/30

(52) U.S. Cl. 707/3; 707/E17.108

(57) ABSTRACT

An entity recommendation system for providing a search result in response to a search request of a user communicated over a communications network. The system comprises a storage for storing a plurality of profiles for a corresponding plurality of registered entities of different entity types, such that the plurality of profiles includes the profile of the user when registered as one of the registered entities. Each of the profiles includes a profile parameter defining a characteristic of the respective registered entity and an entity identifier. The system and method also include a receipt module configured for receiving the search request including an identity of the user and at least one search parameter. The system and method also include a modification module configured for accessing the user profile in the storage based on the user identity matching the corresponding entity identifier and for generating a modified search request including the search parameter and the user profile parameter obtained from the user profile. The system and method also include a search module configured for coordinating a search of a group of entities with corresponding mixed types of the different entity types for determining a plurality of entities matching the parameters of the modified search request, at least one of the matched entities having a corresponding entity profile stored in the storage. The system and method also include a generator module configured for generating the search result as a list of the matched entities including said at least one of the matched entities having the entity profile stored in the storage and a transmit module configured for communicating the search result to the user over the network.

### FIELD OF THE INVENTION

This invention relates to optimisation of search strategies for matching media and other entity types to a search request.

### BACKGROUND OF THE INVENTION

Use of the Internet is growing in popularity due to the ever-expanding placement of information that is accessible on-line through various search tools, such as search engines. Placement of media content, and other content such as advertisements (ads), on-line has grown in popularity due to advantages in revenue generation. Further, the Internet is fast becoming the primary information search tool for obtaining information about products, places, people, etc. Unfortunately, the Internet is also quickly becoming a casualty of it's own success due to unmanageable amounts of available data.

One problem associated with Internet search methodologies is the undesirable volume of search results obtained through a seemingly directed search. The amount of information available on any particular topic can be overwhelming to even the most seasoned Internet searcher. Typically, search results are filled with voluminous information that may not be appropriate for the search context desired by the searcher. Further, the searcher may desire certain media types over others. Certainly, it is a disadvantage to the searcher to have to sift through volumes of search results that seemingly do not pertain to the interests/desires of the searcher.

### SUMMARY OF THE INVENTION

It is an object of the present invention to provide a media recommendation environment to obviate or mitigate at least some of the above-presented disadvantages.

The Internet is fast becoming the primary information search tool for obtaining information about products, places, people, etc. Unfortunately, the Internet is also quickly becoming a casualty of it's own success due to unmanageable amounts of available data. One problem associated with Internet search methodologies is the undesirable volume of search results obtained through a seemingly directed search. Further, the searcher may desire certain media types over others. Contrary to present media systems there is provided an entity recommendation system for providing a search result in response to a search request of a user communicated over a communications network. The system comprises a storage for storing a plurality of profiles for a corresponding plurality of registered entities of different entity types, such that the plurality of profiles includes the profile of the user when registered as one of the registered entities. Each of the profiles includes a profile parameter defining a characteristic of the respective registered entity and an entity identifier. The system and method also include a receipt module configured for receiving the search request including an identity of the user and at least one search parameter. The system and method also include a modification module configured for accessing the user profile in the storage based on the user identity matching the corresponding entity identifier and for generating a modified search request including the search parameter and the user profile parameter obtained from the user profile. The system and method also include a search module configured for coordinating a search of a group of entities with corresponding mixed types of the different entity types for determining a plurality of entities matching the parameters of the modified search request, at least one of the matched entities having a corresponding entity profile stored in the storage. The system and method also include a generator module configured for generating the search result as a list of the matched entities including said at least one of the matched entities having the entity profile stored in the storage and a transmit module configured for communicating the search result to the user over the network.

One aspect provided is an entity recommendation system for providing a search result in response to a search request of a user communicated over a communications network, the system comprising: a storage for storing a plurality of profiles for a corresponding plurality of registered entities of different entity types, the plurality of profiles including the profile of the user when registered as one of the registered entities, each of the profiles including a profile parameter defining a characteristic of the respective registered entity and an entity identifier; a receipt module configured for receiving the search request including an identity of the user and at least one search parameter; a modification module configured for accessing the user profile in the storage based on the user identity matching the corresponding entity identifier and for generating a modified search request including the search parameter and the user profile parameter obtained from the user profile; a search module configured for coordinating a search of a group of entities with corresponding mixed types of the different entity types for determining a plurality of entities matching the parameters of the modified search request, at least one of the matched entities having a corresponding entity profile stored in the storage; a generator module configured for generating the search result as a list of the matched entities including said at least one of the matched entities having the entity profile stored in the storage; and a transmit module configured for communicating the search result to the user over the network.

A second aspect provided is an entity recommendation method for providing a search result in response to a search request of a user communicated over a communications network, the method comprising the acts of: storing a plurality of profiles for a corresponding plurality of registered entities of different entity types, the plurality of profiles including the profile of the user when registered as one of the registered entities, each of the profiles including a profile parameter defining a characteristic of the respective registered entity and an entity identifier; receiving the search request including an identity of the user and at least one search parameter; accessing the user profile in the storage based on the user identity matching the corresponding entity identifier; generating a modified search request including the search parameter and the user profile parameter obtained from the user profile; coordinating a search of a group of entities with corresponding mixed types of the different entity types for determining a plurality of entities matching the parameters of the modified search request, at least one of the matched entities having a corresponding entity profile stored in the storage; generating the search result as a list of the matched entities including said at least one of the matched entities having the entity profile stored in the storage; and communicating the search result to the user over the network.

### BRIEF DESCRIPTION OF THE DRAWINGS

Exemplary embodiments of the invention will now be described in conjunction with the following drawings, by way of example only, in which:

FIG. 1 is a block diagram of components of a media recommendation system;

FIG. 2 shows different example entity types recommended by the system of FIG. 1;

FIG. 3 is a block diagram of an example computing device for implementing the components of FIG. 1;

FIG. 4 shows examples of tags for facilitating recommendation of the entity types for the system of FIG. 1;

FIG. 5 is a block diagram of a media recommendation framework of the system of FIG. 1;

FIG. 6 is a flowchart of operation of the update module of the framework of FIG. 5;

FIG. 7 is a flowchart of operation of the framework of FIG. 5;

FIG. 8 shows an example configuration of the tags of FIG. 4;

FIG. 9a is an example embodiment of a tag cloud of FIG. 8; and

FIG. 9b is an example modified version of the tag cloud of FIG. 9a.

### DETAILED DESCRIPTION OF THE PREFERRED EMBODIMENT(S)

### Media Recommendation System 10

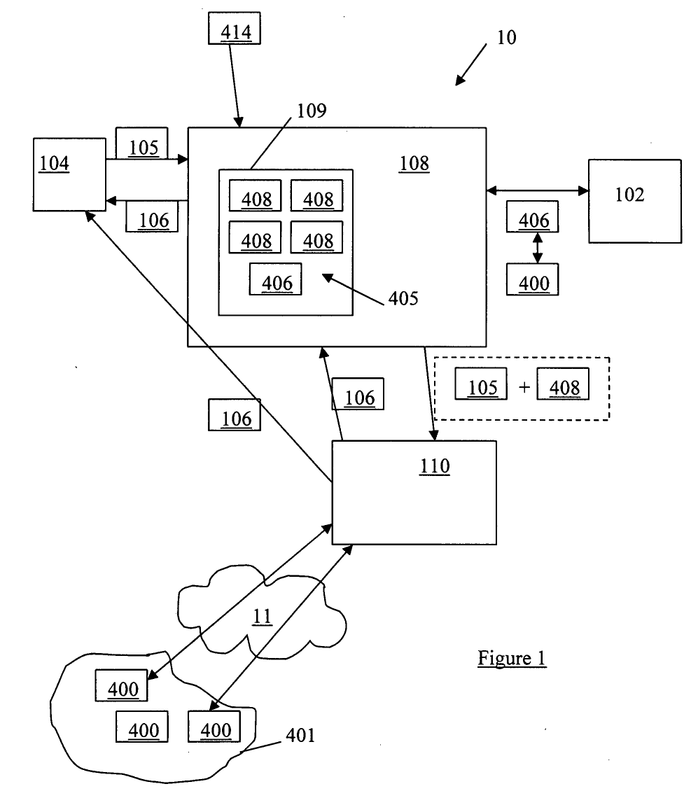

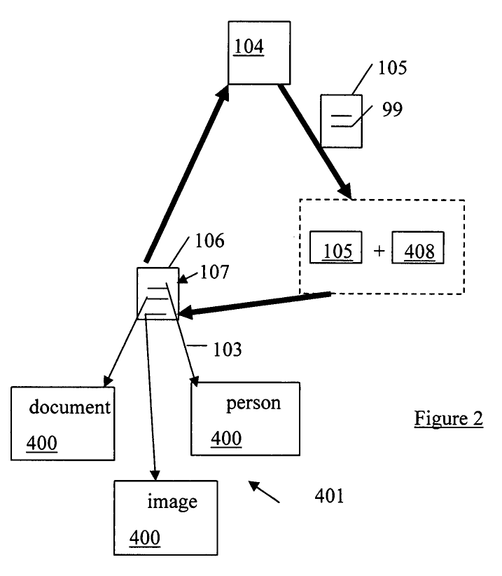

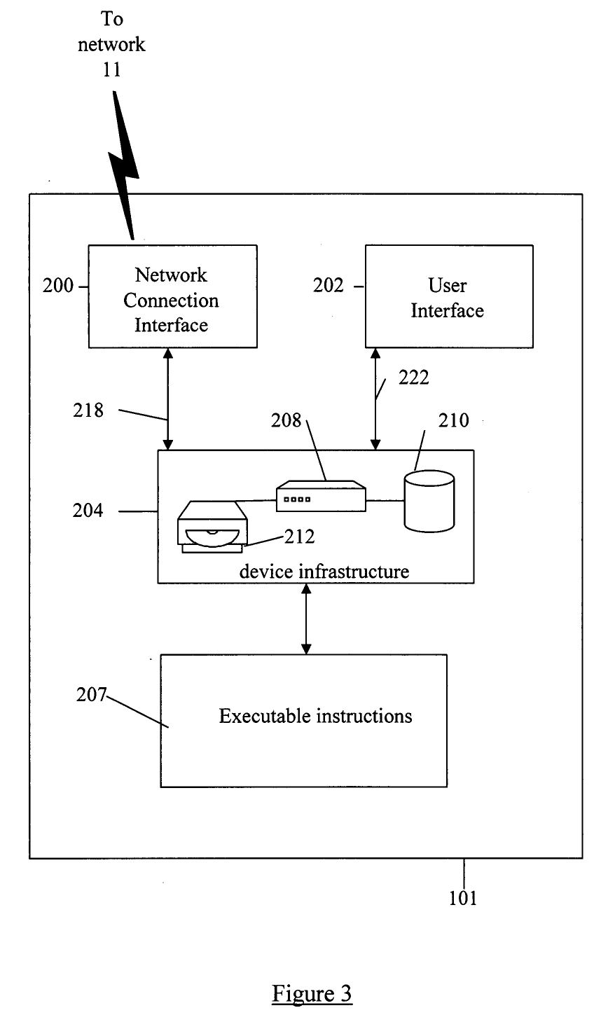

Referring to FIGS. 1 and 2, shown is a media/entity recommendation system 10 for providing search results 106, to a user 104, based on one or more search requests 105. The user 104 is a registered entity 400 of the framework 108 or can otherwise register with the framework 108 as part of the submission process for an initial search request 105. The search request 105 of the user 104 includes search parameters 99 (e.g. keyword terms, phrases, etc.) for use in helping to identify selected entities 400 from a group 401 of available entities, such that reference links 103 (e.g. a list 107 of hyperlinks 103) to the selected entities 400 are included in the search results 106. The entities 400 can include other users 104 (e.g. people, named organizations, etc.) as well as media types such as but not limited to: image files; video files; audio files; Web pages/sites; electronic documents; online advertisements; blogs; and podcasts. The user 104 submits the search request 105 to a media recommendation framework 108 over a network (e.g. network 11) in order to locate desired entities 400 hosted on networked devices 101 (see FIG. 3) that match at least some of the search parameters, e.g. the user 104 wants to locate all entities 400 including images (pictures and video) related to a selected “Celebrity A”. It is recognised that at least some of the entities 400 of the group 401 of entities are registered with the framework 108, as further described below.

The media recommendation framework 108 is used to coordinate the association of tags 405 (see FIG. 1) with each of the entities 400, or group of entities 400, such that the tags 405 and the search parameters 99 of the search request 105 are used to determine the best match (from a group 401 of available entities) as selected ones of the entities 400. It is recognised that coordination of the tags 405 for the entities 400 is facilitated through the use of profiles 504 of the registered entities 400, and if appropriate with suitable information know for the non-registered entities 400 that can be adapted for use in the tag 405 update process 500, as further described below.

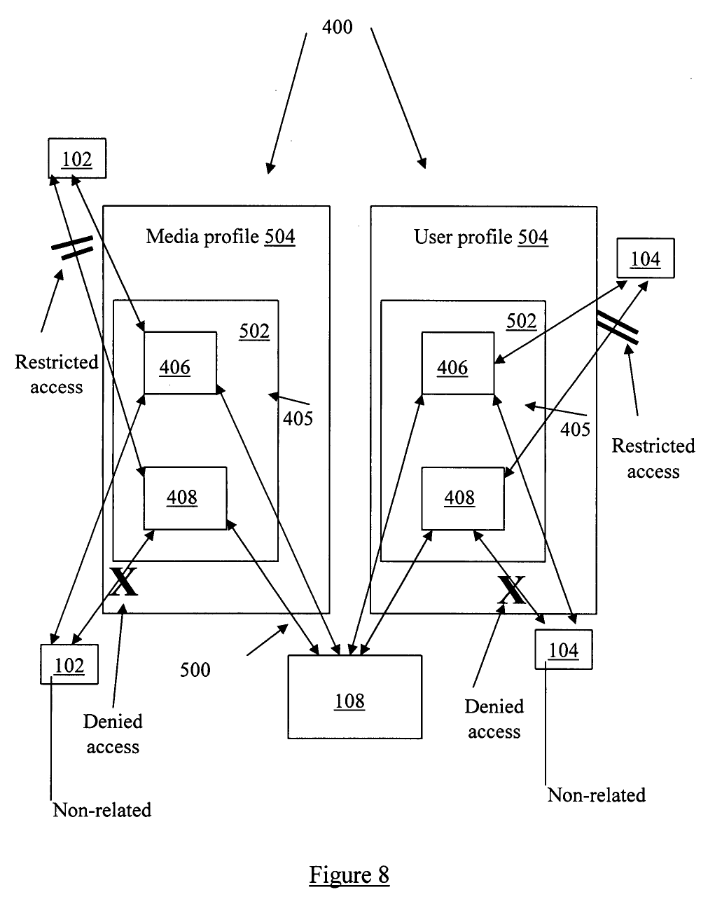

The framework 108 has a table 109 (or other structured memory construct) for storing the private/restricted access tags 408 (or information thereof and/or public/unrestricted access tags 406 that are associated with known entities 400. It is recognised that the public tags 406 can provide identification, categorization, descriptive, and/or labelling information (for example) about the respective entity 400, such that access/knowledge to/of this public information is made available to both the framework 108 and individuals/organizations outside of the framework 108. For example, the user 104 could supply initial public tags 406 to the framework 108 for use in creating a user profile 504 (see FIG. 8). The user 104 would be allowed to subsequently monitor (add/modify/delete tags 406) or otherwise have knowledge of the contents of the public tags 406 contained in their respective profile 504. The user 104 could expect that the predefined public tags 406 would be actively associated/used with their profile 504 in the processing of the search requests 105, unless otherwise advised (e.g. by the framework 108). Similar access/knowledge to/of this public information is made available to both the framework 108 and individuals/organizations (e.g. producers 102) outside of the framework 108 for public tags 406 associated with profiles 504 for media type entities 400.

On the other hand, private tags 408 represent tags 405 to which access/knowledge to/of is restricted in some manner, for those individuals/organisations outside of the framework 108. The private tags 408 can also provide identification, categorization, descriptive, and/or labelling information (for example) about the respective entity 400. The framework 108 assigns private tags 408, based on a private tag 408 assignment process 500 (see FIG. 8) further described below, to a tag cloud/grouping 502 for each entity 400 and places a restriction on access/knowledge to/of the private tag 408 contents to the individual (e.g. user 104) and/or organisation (e.g. producer 102) associated with the defined entity profile 504. For example, based on user 104 interactions with selected entities 400, the private tag 408 set in the tag cloud 502 of the user 104 would be updated without knowledge of the user 104. It is recognised that the degree of restricted access to the private tags 408 information could be varied: such as but not limited to outright restricted access; full/limited access granted upon request of the user 104/organisation 102 to the framework 108; or a combination thereof. In the below described embodiment(s), access to the private tags 408 to those outside of the framework 108 is described as outright restricted access, by example only.

The table 109 of the framework 108 can be used to identify those private tags 408 associated with respective named entities 400. For example, table 109 can include private tags 408 that are associated with the identification (e.g. network URL) of the computing device 101 that is registered to the user 104, as well as private tags 408 that are associated with the identifiers for known entities 400 (e.g. other users/people 104 and/or media). It is also recognised that the private tags 408 can be associated with the hosting devices 101 (e.g. URL) known to host certain entity 400 types (e.g. action movies).

The framework 108 can include a search engine (not shown) or can interact with a third party search engine 110 to determine the selected entities 400 based on the tags 405 and search parameters 99. Also included is a producer 102 that is responsible for making available the media content entities 400 (e.g. media files) through the hosting devices 101, as well as for defining/suggesting public tags 406 for the profile 504 (see FIG. 8) for each entity 400, to assist in matching of the media content entities 400 to the search request 105. It is recognised that the producers 102 (and users 104) only have access/knowledge to public 406 rather than private 408 tags, as further described below.

For example, the user 104 could have private tags 408 (i.e. unknown to the user 104) associated with their user profile 504 (see FIG. 8), for example indicating that the user 104 had accessed action movies from on-line video stores in the past month. Accordingly, the framework 108 would modify the search request 105 (including the name of the Celebrity A), as further described below, to include a preference for action movies (as evidenced through the assigned “action movie” private tag 408 associated with the tag cloud 502 of the user 104), thereby preferentially weighting the search results 106 to include exclusively Celebrity A action movies or to otherwise rank Celebrity A action movies higher in the list 107 of Celebrity A movies/images. In general, the framework 108 can modify the search request 105 with the private tags 408 (associated with the profile 504 of the user 104 and/or selected entities 400) in order to make the search results 106 more applicable to the user 104. It is recognised that the private tags 408 can be assigned by the framework 108 to the user 104 profile 504 and/or to the descriptions/profiles 504 of other entities 400 based on behavioural information 414 (see FIG. 1) related to the user 104 and/or that of other users 104 who accessed those entities 400, as further described below.

This behavioural information 414 is obtained (for example periodically) and is analysed to generate (manually or automatically) keywords/phrases used to create or otherwise dynamically amend the private tags 408 pertaining to the entity 400 associated with the behavioural information 414. Examples of the behavioural information 414 can include information such as but not limited to: on-line browsing history, consumer profiles from third party programs (e.g. reward programs); consumer surveys; and search request 105 history. For example, the search request 105 history could be monitored by the update module 410 for all search terms 99 (see FIG. 2) used by a particular user 104, as well as which of links 103 are selected from a list 107 of references of the search results 106. These search terms 99 as well as the particular links 103 selected, for example, would be used to generate appropriate private tags 408 for the user 104. As well, analysis of the search request 105 history could be used to update the tags 405 of the entities 400 (e.g. media and/or other users 104) that were included in the search results 106.

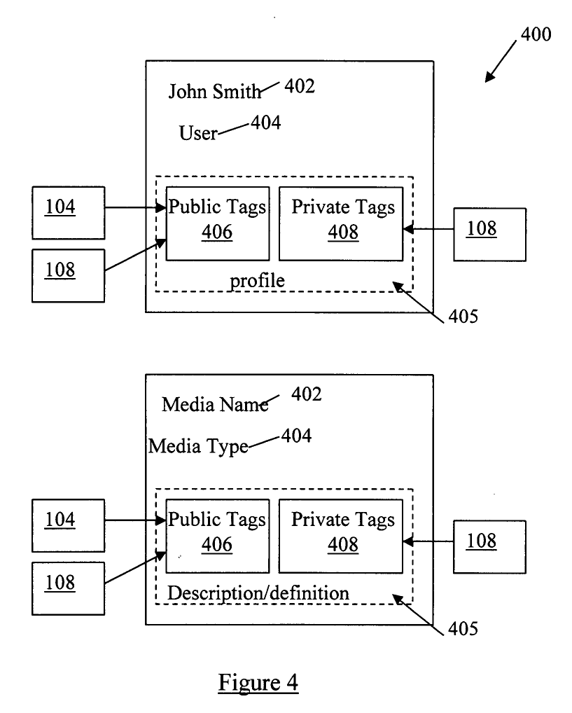

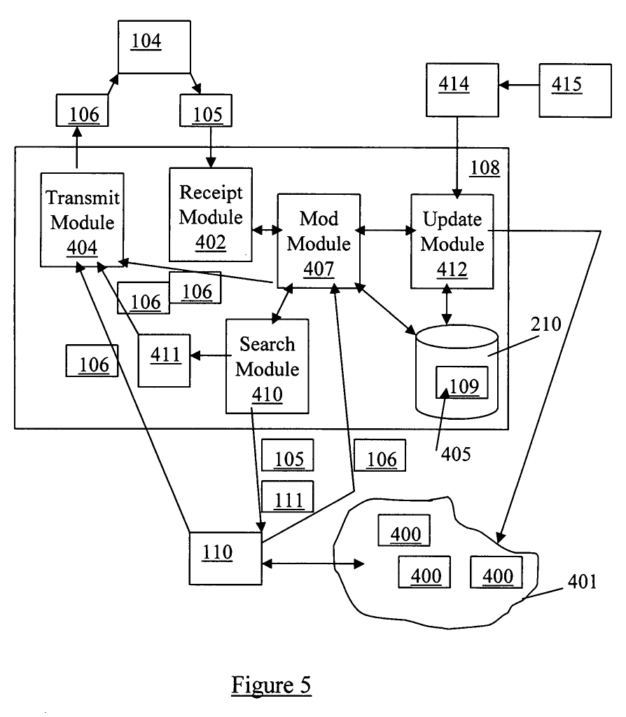

For example, the behavioural information 414 known about non-registered entities 400 can be used to create a profile 504 and corresponding tag cloud 502 for use by the framework 108, as desired. This creation of the tag cloud 502 for the non-registered entities 400 can be done during generation of the search result 106 or can be done after generation of the search result 106. Further, it is recognised that identification of the non-registered entities 400 present in the search results 106, obtained by a search module 410 (see FIG. 5), can be used to initiate the registration of the identified non-registered entities 400 in the search results 106 (e.g. by noting that certain entities 400 in the search results 106 do not have a corresponding entity identifier 402 (see FIG. 4) stored in the memory 210.

Communication between the producer 102, the framework 108, the user 104, the search engine 110 and devices 101 (see FIG. 2) hosting the entities 400 is facilitated via one or more communication networks 11 (such as intranets and/or extranets—e.g. the Internet). The media recommendation system 10 can include multiple producers 102, multiple users 104, multiple search engines 110, multiple hosting devices 101, and one or more coupled communication networks 11, as desired.

It is recognised that the links 103 in the search results 106 can be defined using hypertext. The links 103 can be referred to in general as selectable connections from one word, picture, or information object to another. In a multimedia environment such as the Internet, such objects can include sound and motion video sequences. One example form of the link 103 is a highlighted word or picture that can be selected by the user 104 (with a mouse or in some other fashion), resulting in the delivery and view of another file obtained from one of the hosting devices 101. The highlighted object can be referred to as an anchor, such that the anchor reference and the object referred to constitute the link. In Hypertext Markup Language (HTML), the anchor is the establishing of a term, phrase, image, or other information object as being either: the target of the hypertext link 103 within a document, or a reference (a link you can select) to such a target.

Further, for example, interaction with the links 103 (see FIG. 2) by the user 104 can pertain to interest in (and potential purchase) of products through merchant's on-line advertisements contained in the search results 106. The framework 108 can make these product links 103 available to the user 104 in exchange for commissions on leads, sales, and/or general interest shown by the user 104 in company products via usage of the links 103. It is recognised that the links 103 can include link mechanisms such as but not limited to: Inline Text Links; Text Banners; Graphical/Rich Media Banners; In-page Graphical Banner; Pop-Unders/Ups; XML Feeds; Layer Ads; and Search box, for example. Monitoring of the interaction of the user 104 with certain product links 103 can be used to identify behavioural information 414 of the user 104 (or users 104 associated with access to a particular entity 400) and thus be used to update the private tags 408, as further described below. The behavioural information 414 can also be supplied to the framework 108 from third party suppliers (e.g. award programs, travel agencies, etc.) who monitor behaviour (e.g. purchase(s), travel, other activities such as hobbies, interests, etc.) of selected users 104 and their interaction with identified entities 400.

In economics, economic output is divided into goods and services. When an economic activity yields a valuable or useful thing, it can be known as production output of the totality of products (e.g. goods or services) in an economy that the company makes available for use by the users 104. Products as goods can range from a simple safety pin, food, clothing, computer components to complex aircraft. Products as services are the performance of any duties or work for another (e.g. helpful or professional activity) and can be used to define intangible specialized economic activities such as but not limited to: providing access to specific information; web services; transport; banking; legal advice; accounting advice; management consultant advice; and medical services. The company providing the products can be a businessperson/individual engaged in wholesale/retail trade, an organization, an administration, and/or a business that sells, administers, maintains, charges for or otherwise makes available product(s) that are desirable by the users 104. Accordingly, the company can be one person, or an association of persons, for the purpose of carrying on some enterprise or business; a-corporation; a firm; etc. Further, it is recognised that the use of the links 103 can be applied to direct the user 104 to company activities not related to specific product(s), for example customer service, community activities, and/or sponsorships. These general activities of the company are also considered as part of the definition of company products.

Further, it will be understood that for the purposes hereof, the user 104 may be an individual who purchases goods and/or services for personal use, and not for resale or for use in the production of other goods and/or services for resale. Or the user 104 may be a business purchasing good and/or services for use in its business, i.e., for resale or for use in the production of other goods and/or services for resale.

### Computing Devices 101

Referring to FIGS. 1 and 3, each of the above-described components of the system 10, i.e. the producer 102, the framework 108, the user 104, the search engine 110 and hosting devices 101 of the entities 400, can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the network 11 (e.g. an intranet and/or an extranet such as the Internet), which enables the devices 101 to communicate with each other as appropriate. The network 11 can support the communication of the search request 105 and the corresponding search results 106 between the components of the system 10.

Referring again to FIG. 3, the devices 101 can also have a user interface 202, coupled to the device infrastructure 204 by connection 222, to interact with a user (e.g. producer 102, user 104, search engine 110 administrator, framework 108 administrator, etc.). The user interface 202 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the users 104 can be configured to interact with a web browsers (e.g. applications 207) to formulate the search requests 105 as well as process the received search results 106 (e.g. access via the links 103 the matched entities 400 available on websites (e.g. applications 207) of the hosting devices 101. For the devices 101 used by the framework 108, the user interfaces 202 can be used by a framework 108 administrator to associate (e.g. manually or automated through association software—e.g. applications 207) the tags 405 with the user 104 and/or the entities 400, as further described below.

Referring again to FIG. 3, operation of the devices 101 is facilitated by the device infrastructure 204. The device infrastructure 204 includes one or more computer processors 208 and can include an associated memory 210 (e.g. a random access memory). The computer processor 208 facilitates performance of the device 101 configured for the intended task through operation of the network interface 200, the user interface 202 and other application programs/hardware 207 of the device 101 by executing task related instructions. These task related instructions can be provided by an operating system, and/or software applications 207 located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update client applications 16. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination. The device memory 210 and/or computer readable medium 212 can be used to store the profile 504 information of the user 104 of the device 101, such that the profile 504 information is used in processing of the search requests 105 submitted from the device 101 to the network 11.

Further, it is recognized that the computing devices 101 can include the executable applications 207 comprising code or machine readable instructions for implementing predetermined functions/operations including those of an operating system, a web browser, the framework 108 for example. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality of the framework 108 (e.g. modules 402,404,407,410,412, and subset thereof may be implemented in hardware, software or a combination of both. Accordingly, the use of a processor 208 as a device and/or as a set of machine-readable instructions is hereafter referred to generically as a processor/module for sake of simplicity. Further, it is recognised that the framework 108 can include one or more of the computing devices 101 (comprising hardware and/or software) for implementing the modules 402,404,407,410,412, or functionality subset thereof, as desired.

It will be understood that the computing devices 101 of the users 104 may be, for example, personal computers, personal digital assistants, mobile phones, and content players. Server computing devices 101 can be configured for the framework 108, producers 102, entity 400 hosting devices, and search engine 11,0) as desired. Further, it is recognised that each server computing device 101, although depicted as a single computer system, may be implemented as a network of computer processors, as desired.

### Tags 405

Referring to FIG. 4, the tags 405 are single/multiple alpha and/or numeric descriptors (e.g. words) used to categorize or otherwise label content (e.g. entities 400) so that the entity-matching framework 108 (see FIG. 5) can match entities 400 with one another from a group 401 of available entities 400. The tags 405 are (relevant) keyword(s) or term(s) or phrases associated with or otherwise assigned to the entity 400 (e.g. users, pictures, articles, video clips, etc.), thus describing the entity 400 and enabling a descriptive/keyword-based classification of the entities 400. The tags 405 can refer to metadata involving the association of descriptors with objects and can be embodied as the syntax (e.g. an HTML tag/delimiter such as a coding statement) used to delimit the start and end of an element, the contents of the element, or a combination thereof.

Referring to FIGS. 4 and 8, each of the entities 400 has associated with it one or more of the tags 405, as part of a predefined entity classification system/process 500. Each of the entities 400 can have a respective profile 504 including an identifier 402 (e.g. name, URL, address, and other communication/contact information), a type 404 (e.g. user or other media such as audio, video, print, picture, etc.), and/or an associated tag cloud 502. It is recognised that the identifier 402 and the type 404 could be separate from and/or included as tags 405 in the tag cloud 502. The tag cloud 405 includes public tags 406 and optional private tags 408. The framework 108 accesses the tags 405 of the entities 400 (e.g. through the respective profile 504) in order to link/match those entities 400 that contain the tags 405 (or even to specified collections of tags 405) matching the parameters 99 of the initial search request 105 as well as the modified search request via the modification module 407 further described below. It is noted that the tags 405 used in matching entities 400 to the search request 105 can be used in addition to the included search parameters 99 (see FIG. 1) of the search request 105.

The tags 405 can be defined using a structured definition language such as but not limited to the Standard Generalized Markup Language (SGML), which defines rules for how a document can be described in terms of its logical structure (headings, paragraphs or idea units, and so forth). SGML is often referred to as a meta-language because SGML provides a “language for how to describe a language.” A specific use of SGML is called a document type definition (DTD), which defines exactly what the allowable language is. For example, Hypertext Markup Language (HTML) is an example of a structured definition language for defining the tags 405. A further example of the structured definition language is Extensible Markup Language (XML), which defines how to describe a collection of data. Accordingly, the tags 405 can be used to provide an underlying definition/description of the entities 400. For example, HTML delimiters can be used to enclose descriptive language (e.g. tags 405) about an HTML page, placed near the top of the HTML in a Web page as part of the heading.

There can be several kinds of tag 405 types useful for search engine indexing, tags 405 such as but not limited to a keywords meta tag 405 and a description meta tag 405. The keywords meta tag 405 can be used to list the words or phrases that best describe the contents/attributes of the entity 400. The description meta tag 405 can be used to include a brief one- or two-sentence description of the entity 400. It is recognised that both the keywords and the description, of the tags 405, are used by the framework 108 to identify, and return, search results 106 appropriate to the search request 105 context desired by the user entity 400. It is recognised that the description of the tags 405 may be included in the search results 106 to provide a summary of each of the entities 400 returned in the search results 106, and/or link thereto. It is also recognised that the tags 405 can be used to help rank the entity 400 with respect to other entities 400, as further described below with reference to the process 500. It is recognised for entities 400 representing people, the tags 405 can be used to help define the profile 504 for the users 104.

### Tag 405 Examples

The following are example of tags 405 used to match entities 400 from the group 401 of entities 400 based on the search request 105 and/or profile 504 of the user 104 originating the search request 105, and/or the profile 504 of the respective entities 400 in the group 401 of entities.
<META name=“resource-type” content=“document”>
   the resource type tag 405 can include types such as but not limited to document, video, people, image, audio, blogs, etc.
<META name=“description” content=“a description of the entity 400”>
   the description type tag can be displayed along with the title of the entity 400 in an index. “content” could be a word, sentence or even paragraph to describe the entity 400.
<META name=“keywords” content=“a, list, of, keywords”>
   the keywords type tag 405 can include one or more descriptive keywords, separated by commas. The keywords can include synonyms, colloquialisms, and so on. For example, if the entity 400 is related to cars, the keyword tags 405 can include “car”, “cars”, “vehicles”, “automobiles”, autos, etc.
<META name=“distribution” content=“one of several”>
   the distribution type tag 405 can be used to list available resources to find things, such that the content should contain either global, local or IU (Internal Use).

Other examples of tags 405 include: a specific XML definition, such as Microsoft's Channel Definition Format (CDF), which defines a set of tags 405 for describing a Web channel; and an ID3 tag as a type of meta data container used to store information about an MP3 file (e.g. entity 400 such as a podcast) within the audio file itself. The ID3 tag 405 allows the creator of a file to embed relevant information (including hyperlinks and images) like the name of the artist, track title, album, track number and genre in the file, allowing that information to travel with the file. It is also recognised that the metadata can be defined as a set/list of descriptors (words, phrases, etc.) that are indexed or otherwise associated with the individual entities to comprise individual tags 405 or group tags 405, e.g. each word/phase is classified as a separate tag 405 and/or a group of words/phrases is classified as a single tag 405.

### Public 406 and Private 408 Tags

The framework 108 administers the association of the tags 405 to respective entities 400. It is recognised that either or both of the framework 108 and the producer 102 of the entity 400 can assign the public tags 406 to the entity 400. For example, a webpage containing articles on luxury automobiles could contain public tags 406 including descriptions of well-known luxury cars, keywords related to luxury car brands, etc, as provided to the framework 108 by the producer 102 of the article (i.e. both the producer 102 and the framework 108 share knowledge of the producer 102 supplied public tags 406 for the respective entity 400). Another example is where the user 104 (e.g. also defined generically as one of the entities 400) would supply the profile 504 description of themselves containing the public tags 406, e.g. user name, user age, user occupation, user geographic location, interests, etc. It is recognised the public tags 406 may or may not be shared with other producers 102/users 104 not associated with the entity 400, as desired. For example, user “A” may supply public tags 406 to the framework 108 for inclusion in their respective profile 504 (i.e. thereby setting up shared knowledge of the supplied public tags 406 between the framework 108 and the user A for it's profile 504). However, the framework 108 could restrict access to these public tags 406 by other users 104 (and/or producers 102, entities 400) not related to user “A”.

Further, it is recognised that the search requests 105 and/or the corresponding search results 106 may also contain these public tags 406, but the actual identity of the user 104 (or identity of the producer 102 of the entities 400) make be kept, or otherwise obscured/aliased 403 (see FIG. 8), from the contents of the modified search request 105 sent to the search engine 110, as desired. This obscuring of the actual user 104/producer 102 identity in the search request 105 could be useful in restricting knowledge from the search engine 110 (or other third parties outside the framework 108 having access to the search request 105 contents) to which actual user 104/producer 102/entity 400 the public 406 and/or private 408 tags belong. Accordingly, the framework 108 would keep track of which search results 106 correspond to the aliased search request 105. Knowledge of the alias 403 could be also stored in the entity profile 504 for repeated usage and/or otherwise stored in the table 109 for temporary usage (e.g. newly generated alias for each new search request—for example done by the module 407), as desired.

On the other hand, the private tags 408 are assigned to the entities 400 by the framework 108 and are not made available/shared outside the framework 108. For example, the framework 108 restricts knowledge/access of the user 104 (or producer 102) for private tags 408 contained in the profile 504 of user 104, as well as restricts knowledge/access of the user 104 (or the producer 102) for private tags 408 contained in the description/definition profile 504 of media content entities 400. The private tags 408 are assigned to the entities 400 by the framework 108 to help provide better context/sourcing for matching entities 400 to one another. It is recognised that the assignment of private tags 408 by the framework 108 to respective entities 400 can be done on a dynamic basis, e.g. for example for a specified update period such as a 90 day window, as further described below. The dynamic update of the private tags 408 can be the result of behavioural analysis of the entities 400 for the specified update period, as further described below.

One example of private tags 408 are keywords that are representative of the character traits (e.g. behavioural information 414) of users currently accessing certain media entities 400, which demonstrates monitoring of behavioural patterns with respect to the certain entities 400. For example, the framework 108 could note that a specific audio file (e.g. entity) is accessed predominantly by individual users that are known to be overweight and male. Accordingly, the keyword tags of “overweight” and “male” as behavioural information would be added by the framework 108 to the private tags 408 of the audio file. In the future, if tracking of access to the specific audio file (by the framework 108) notes that chronically overweight males and females are predominant, then the framework 108 would change the keyword tags to include “chronically overweight”, “male”, and “female” private tags 408. These private tags 408 would not be accessible by the producer 102 of the specific audio file nor by the individual users accessing the specific audio file. One reason for limiting knowledge of the keywords used as private tags 408 is that: the producer 102 of the specific audio file entity 400 may not appreciate or otherwise agree with the association of tags 408 for “chronically overweight”, “male”, and “female” with their entity 400; and/or the individual users may not appreciate or otherswise agree with the explicit labelling of “chronically overweight”, “male”, and “female” included in their entity 400 public profiles 504 (e.g. through public tags 406).

A further example of selecting private tags 408 to associate with an entity 400 is using behavioural analysis of a selected user 104. For example, behavioural information 414 related to the selected user 104 could include information such as but not limited to: history of access to certain entities 400 including entity type and frequency/timing of access; history of access to new entities 400 not from the usual certain entities 400; identification details of the browser 207 and/or of device 101 of the user; information on the user and/or user device 101 obtained from a third party information database (not shown)—example air miles or other reward programs; browsing behaviour and/or user profile, shopping profile, or other user profile data not included in the public tags 406; or a combination thereof. It is recognised that browsing behaviour can include behaviour 414 such as but not limited to: user clicks (on-click event) on a link or performs some other user action (e.g. mouse-over/hover event) during interaction with selected entities 400 obtained from prior search results 106; type of online ads interacted with; number of interactions with selected entities 400 (e.g. visits to a particular Web page); the amount of time spent on a particular Web page; etc.

The behavioural information 414 of the user 104 can be monitored by the framework 108, can be supplied to the framework 108 by a third party, or a combination thereof. Again, in the context of user 104 profiling 504, it is recognised that the users 104 may not appreciate the association of certain tags 405 to their entity 400 description (e.g. user profile 504), hence the usefulness of private tags 408 to embody the known behavioural information 414 of the user 104. Accordingly, access to private tags 408 details, that are part of the tag cloud 502 for a respective entity 400, is restricted by the framework 108 for those individuals/organizations that are external or are otherwise not associated/related to the framework 108.

### Example Operation for Updating of Tag Clouds 502

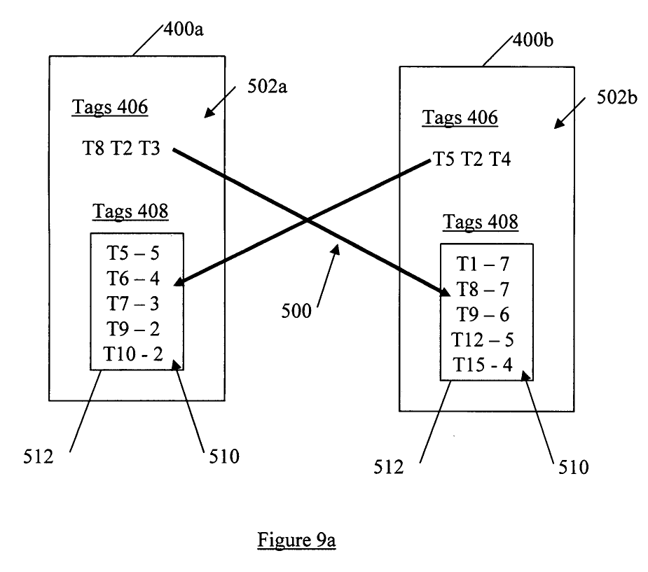

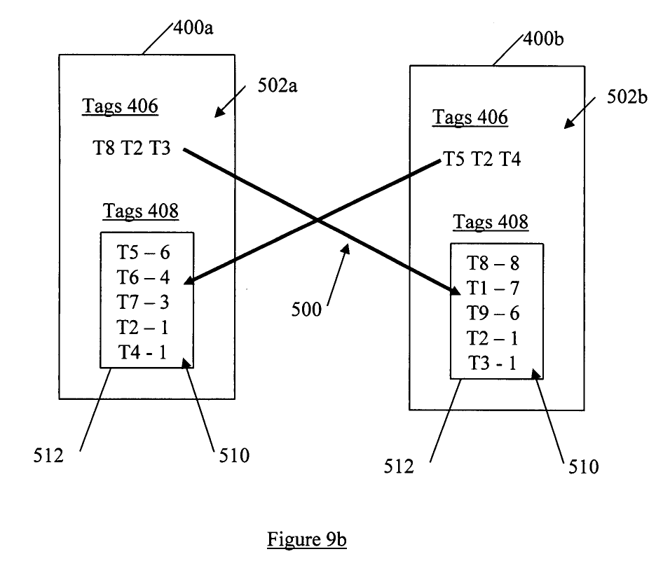

Referring to FIG. 9a, shown are two entities 400a and 400b that each have a set of private 408 and public 406 tags. Entity 400a includes the tag cloud 502a of the user 104 that initiated the search request 105 for various media entities 400, a sample of which is represented by entity 400b. The tag cloud 502a has public tags 406 of T2, T3, T8 and private tags 408 of T5, T6, T7, T9, and T10, for example. Likewise, the tag cloud 502b of the media entity 400b has public tags 406 of T2, T4, T5 and private tags 408 of T1, T8, T9, T12, and T15, for example.

It is noted that the number of private tags 408 for each entity 400a,b are limited in either number and/or time period via a predefined window 512. In other words, the private tags 408 are dynamically assigned to the window 512, based on the level of interaction of the entity 400a,b with other entities 400a,b. For example, the window 512 could be configured as a container or queue for holding a predefined number of tags 408 (e.g. maximum and/or minimum), which could be useful in situations in which there are a large number of different potential tags 408 applicable for the tag cloud 502a,b (e.g. environments with large numbers of search request 105 activity and/or numerous receipts of new behavioural information 414). The actual value of the predefined number of tags 408 can be selected to facilitate a reasonable number of tags 408 resident in the window 512 with a desirable frequency of tag 408 turnover, bearing in mind that the actual tags 408 included in the tag cloud 502a,b are for representing the searching behaviour/preferences of the entity 400a,b. For example, setting the number of predefined tags 408 too low could result in an undesirable turnover frequency (i.e. overly rapid replacement of lower ranked tags 408 by newly assigned tags 408) of the tags 408 in the window 512. On the other hand, setting the number of predefined tags 408 too high could result in too many tags 408 resident in the window 512 that are not properly representative of the current behaviour/preferences of the entity 400a,b.

Another example of window 512 configuration is where the window 512 could be set up as a container or queue for holding the tags 408 resident for a specified period of time, e.g. say a 90 day window. Therefore, any resident tag 408 older than the specified time period would be deleted from the window 512, bearing in mind that the actual tags 408 included in the tag cloud 502a,b are for representing the searching behaviour/preferences of the entity 400a,b. For example, setting the specified time period too low could result in an undesirable turnover frequency (i.e. overly rapid deletion of the oldest ranked tags 408) of the tags 408 in the window 512, thus causing a potential problem of a lack of a reasonable number of resident tags 408, in situations where there is a low degree of search request 105 activity or receipt of new behavioural information 414 used to provide for a supply of new tags 408 for assignment to the window 512. On the other hand, setting the specified time period too high could result in too many tags 408 resident in the window 512 that are not representative of the current behaviour/preferences of the entity 400a,b. It is also recognised that setting of the extent of the window 512 can include a combination of both the specified time period and a predefined maximum/minimum number of the resident tags 408, as desired.

Further, the private tags 408 each have an individual ranking 510 (e.g. tag T5 has a ranking of “5” which is higher that the ranking of “4” for tag T6, included in tag cloud 502a). This assigned ranking 510 is used to denote an ordered degree of usefulness of the resident tags 408 in supplementing the tags 406 for defining the overall tag cloud 502 of the profiles 504. One example is where the ranking 510 represents the matching frequency (or otherwise usage of the tag 408 in conducting of the various search requests 105) of each private tag 408 with that of a corresponding entity 400a,b, as further described below. The ranking 510 can also be represented as the amount of time (e.g. based on a date stamp) a particular tag 408 has been resident in the window 512. It is also recognised that the ranking 510 can be a combination of age and frequency related parameters.

Referring to FIG. 9b, shown is the situation where the window 512 has been set for a predefined number of resident tags 408, e.g. 5. Based on the earlier search results 106 from user entity 400a, the media entity 400b was selected from the group 401 of entities 400 (see FIG. 1). An update module 412 (see FIG. 5) updates the tags 408 of the tag clouds 502a,b by including any new tags 406 from the tag cloud 502b in the window 512 of the tag cloud 502a and vice versa, if desired. This would result, for the example given, that tags T2 and T4 being added with an initial ranking 510 (e.g. a usage frequency of “1”) to the private tags 408 of the tag cloud 502a and updating the current ranking 510 of the tag T5 (e.g. usage frequency changing from present “5” to new “6”). It should also be noted that since the window 512 of the tag cloud 502a was at capacity (e.g. at the maximum number of tags 408 set as five), tags T9 and T10 with the lowest raking 510 of “2” were replaced by the new tags T2 and T4 with an initial ranking 510 of “1”, thus maintaining the maximum number of resident tags 408 as predefined. Similarly, the private tags 408 of the tag cloud 502b can be updated with the tags 406 of the tag cloud 502a, as shown by example. It is also recognised that the behavioural information 414 received by the framework 108 (see FIG. 1) could also be used to define appropriate new tags 408 for assignment to the window 512 of the corresponding entity 400 or entities 400, as desired.

Further, in general it is recognised that the dynamic updating of the tags 408 in the window 512 could be happening in search result 106 environments containing numerous entities 400b matched and/or interacted with by the user entity 400a, thus providing for numerous updates of the private tags 408 of the tag cloud(s) 502 for the various contents of the public tags 406 of each of the entities 400b in the search results 106. In this case, the framework 108 could be configured to limit the update activity of the private tags 408 using a limited number (e.g. predefined) of the entities 400 (e.g. from the top of the list 106—see FIG. 2 or other defined distribution of the list entries) from the search results 106 and/or based monitoring of which links 103 of the list 107 are actually selected or otherwise interacted with by the user 104. In more voluminous search result 106 environments, the window 512 can be configured using a tag 408 number limit of say 150 and for ordering the resident tags 408 in descending order of ranking 510. It is further recognised that the new tags 408 selected for assignment in the window 512 can either replace existing resident tags 408 or be appended to the list of resident tags 408. As well, exchanges between private tags 408 of the tag clouds 502a,b can also be done as described above for the updating using public tags 406.

Further, it is recognised that new tags 408 considered as candidates for inclusion into a particular tag cloud 502 can be first held in a temporary cache until referenced again or otherwise for a set frequency. Once the set frequency is met then the new tag 408 is assigned to the window 512. For example, say the user 104 obtains search results 106 that contain three entities 400, namely E1, E2, E3. Each of the entities 400 contains the tag T1 that is not currently resident in the window 512 of the user 104. The update module 412 first encounters the new tag T1 upon inspection of the tag cloud 502 of entity E1 and notes that the tag T1 is not currently resident in the window 512 of the user 104. The update module 412 stores the tag T1 (or reference thereto) in a cache (e.g. of the memory 210—see FIG. 5). Upon inspection of the tag cloud 502 of entity E2, the update module 412 again encounters the potential new tag T1 and also notes that it is already stored in the cache pending confirmation of repeat activity. At this stage, the update module 412 can decide to assign the tag T1 to the tags 408 in the window 512 of the user 104 (e.g. an example of a set frequency of 2) with an appropriate initial ranking 510 (e.g. “1” signifying that T1 is newly entered). Upon inspection of the tag cloud 502 of entity E3, the update module 412 again encounters the tag T1 and therefore updates the ranking of T1 now already resident in the window 512 (e.g. changes the ranking 510 from “1” to “2”). Accordingly, the use of the cache by the framework 108 can be used to inhibit updating of the window 512 with new tags 408 that are not representative of repetitive or otherwise characteristic of the entity 400 interaction of a particular entity 400 (e.g. user 104).

The following is an example algorithm for use by the update module 412, for example, in updating of the tags 408 resident in the window 512 of the entity 400.

```
{
int nTags = System.Math.Max(maxTags,
(int)System.Math.Round((float)(Count * maxPercent)));
nTags = System.Math.Min(nTags, Count)
List<Tag> I = new List<Tag>(this.Values);
I.Sort(BSideUniqueComparer);// ben 1203
I = I.GetRange(0, nTags);
return new TagCollection(I);
}
static int BSideUniqueComparer(Tag x, Tag y)
{
    // if x has more wieght than y, then x wins
    if (x.Wieght != y.Wieght)
    return y.Wieght.CompareTo(x.Wieght);
    // if x has more hits than y, then x wins
    if (x.Hits.CountUnique( ) != y.Hits.CountUnique( ))
    return y.Hits.CountUnique( ).CompareTo(x.Hits.CountUnique( ));
    // ben 1203
    DateTime dt = (DateTime)x.Hits.MostRecent;
    if (x.Hits.MostRecent != y.Hits.MostRecent)
      return y.Hits.MostRecent.CompareTo(x.Hits.MostRecent);
    return 0;
}
#endregion
#region Dal
public bool Store( )
{
    foreach (Tag t in this.Values)
    {
    Store(t);
    }
    return true;
}
```

Further, it is also recognised that the public tags 406 could also be updated using the above described dynamic assignment methodology of the private tags 408. Actual replacement/appending of public tags 406 (in a defined “public” window 512, if desired to limit the number of public tags 406) for a particular entity 400 can be done via a number of different options, such as automatically or semi automatically. For semi automatically, the entity 400 may be provided with an option by the framework 108 on whether a proposed tag 406 update is acceptable. If upon inspection of the proposed new public tags 406, the user 104 (or producer 102 in the case of media entities 400) can provide permission to the framework to implement the proposed tag 406 update. Update of the public tags 406 can be done on a predefined periodic or continual basis, as desired.

Based on the above, it is recognised that the content of the tags 406 and/or tags 408 can be regarded as static or dynamic, as configured by the framework 108. It is recognised that the content status (e.g. static or dynamic) can be adjusted for selected entities 400, as desired. For example, a producer 102 can decide to first keep the tag cloud 502 content for a selected media entity as static, in order to see what the interaction activity of the entity would be by the users 104 via their search requests 105 and corresponding search results 106. The producer 102 could then try out a trial period by changing the content status of the tag cloud 502 content to dynamic, thus allowing for dynamic updating of new tags 406,408 to the tag cloud 502 based on the users 104 search requests 105 and corresponding search results 106. The producer 102 could then look at a comparison of the entity 400 access activity between the static tag cloud 502 and the dynamic tag cloud 502, and therefore decide on how to best represent the tag cloud 502 of the selected entity.

### Entity Recommendation Framework 108

Referring to FIG. 5, shown is one embodiment of the recommendation framework 108 for processing of search requests 105, providing search results 106, and updating the tag clouds 502 of respective entities 400, for example.

The Framework 108 includes a receipt module 402 for receiving the search requests 105 for processing, and a transmit module 404 for sending the corresponding search results 106 to the user 104. A request modification module 407 receives the search request 105 from the receipt module 402 and identifies the corresponding user profile (e.g. tags 405) from the user table 109 in storage 210. The modification module 407 then amends the parameters 99 (see FIG. 2) of the search request 105 by adding additional parameters 99 according to the contents of the private tags 408 and optionally the public tags 406. The modified search request 111 is then sent to a search module 410, which interacts with the search engine 110 in order to obtain entities 400 that best match the search request 111. Also included is an update module 412 configured for monitoring or otherwise receiving behavioural information 414 (and/or inspecting the tag clouds 502 of the entities 400 of the search results 106) of selected entities 400, determining appropriate private tags 408 (and/or public tags 406) representing predefined changes to the content of the tag clouds 502, as given by example above, and then updating/creating/deleting private tags 408 (and/or public tags 406) associated with the corresponding entity 400 in the table 109.

Also included is a generator module 411 for generating the search result 106 as the list 107 of the matched entities 400 including at least one of the matched entities 400 having an entity profile 504 stored in the storage 210. Accordingly, it is recognised that the search results 106 can contain entities 400 that are registered with the framework 108 or a combination of registered and non-registered entities 400. In the case of non-registered entities 400, it is recognised that these non-registered entities 400 (i.e. with the framework 108) may not have a profile 504 (as noted for the registered entities 400) and/or may not have associated private tags 408. In the event that the non-registered entities 400 do not have a profile and/or private tags 408 suitable for use in updating of the profile 504 of other matched entities 400, as given by example above, the non-registered entities 400 may not be included in the tag 405 update process 500 as implemented by the update module 412. It is also recognised that the

### Receipt Module 402

The receipt module 402 can be part of the network connection interface 200 (see FIG. 3) of the device 101 operating the framework 108. The module 402 can communicate synchronously or asynchronously with the device 101 of the user 104 over the network 11.

### Transmit Module 404

The transmit module 404 can be part of the network connection interface 200 (see FIG. 3) of the device 101 operating the framework 108. The module 404 can also communicate synchronously or asynchronously with the device 101 of the user 104 over the network 11, in accordance with the parameters 99 of the search request 105 as well as the configuration of the receipt module 402, as desired.

### Request Modification Module 407

Referring again to FIG. 5, one embodiment of the modification module 407 is to amend the parameters 99 of the search request 105 by analysing the tag cloud 502 of the entity 400 (e.g. user 104 initiating the request 105). The modified search request 111 would then be sent to the search engine 110, for example, in order to obtain search results 106 consistent with the modified search request 111. The framework 108 could also send both requests 105,111 to the search engine 110, in order to compare the quality of the respective sets of search results 106. The quality of the search results 106 could be tested by the framework 108 through monitoring of which of the search results 106 precipitated a greater degree of change to the content of the tag cloud 502 of the user 104, for example.

A further embodiment of the module 407 is where the unmodified search request 105 is first sent to the search engine 110 to determine entities 400 matching the search parameters 99. Upon receipt of the search results 106, the module 407 uses the private tags 408 of the user 104 to modify or otherwise rank the order of the links 103 in the search result list 107 (see FIG. 2). This modified search result 106 is then sent back to the user 104, for example via the generation module 411 for generating the entity list 107 to include entities 400 registered in the storage 210 that match the search request parameters 99 and tags 405 from the user profile 504. For example, the user 104 indicated in the search parameters 99 of the search request 105 that they would like to see articles with images of a named celebrity. Upon receiving the search results 106, the module 407 notes that the user has private tags 408 indicating preferences for other named celebrities. The module 407 would then reorder the search results based on these private tags 408, thus providing the list of links 103 with one or more entity 400 categories (e.g. images of just the named celebrity, images of other related celebrities, and images of the named celebrity when with the other named celebrities).

A further example of the entity 400 categories would be such as but not limited to: the top ten celebrity articles including the other named celebrities; the top ten celebrity web sites pertaining to the named celebrities; the top ten videos of the named celebrities; the top ten blogs having entries pertaining to the named celebrities; the top ten fans (e.g. other users 104) of the named celebrities; etc. It is noted that the search results 106 can have a variety of mixed entity types 404 (see FIG. 4) in the list 107, as desired, as well as a plurality of categories based on the initial search terms 99 of the search request 105 as well as the private tags 408 of the user 104 and/or the entities 400 in the list 107. Ranking of the entities 400 in each of the categories can be done as is known in the art. Further, it is noted that inclusion of entities 400 or otherwise as links 103 thereto, related exclusively to search parameters 99 associated solely with the private tags 408 of the user 104, can be provided in the search results 106 in such a way so as to inhibit recognition by the user of their private tags 408 (e.g. distributed throughout the search results 106 to resist obvious patterns).

### Search Module 410

The search module 410 communicates with the search engine 110 (or a plurality of search engines—not shown) in order to facilitate obtaining of search results 106 that are most relevant to the user 104. The search engine can be part of the search module 410 and/or linked to the search module 410 via the network 11.

The search engine 110 can be referred to as a coordinated set of programs that can include: a spider that goes to every page or representative pages on every Web site that wants to be searchable and reads it, using hypertext links on each page to discover and read a site's other pages; a program that creates a huge index (sometimes called a “catalog”) from the pages that have been read; and/or a program that receives the search request 105 (or modified request 111, compares it to the entries in the index, and returns results in the form of the search results 106, for example. The search can also include an exploration of a structured directory of topics. The search engine 110 can also be provided as a number of Web portal sites that offer both the search engine 110 and directory approaches to finding information pertaining to the search terms 99 (see FIG. 2).

It is recognised that specialized content search engines 110 can be utilized by the framework 108, which are selective about what part of the Web is crawled and indexed. For example, the specialized search engines 110 can selectively index only the best sites about selected products and provide a shorter but more focused list of results. It is recognised that the private tags 408 could also be attached to the profile of the specialized search engines 110 based on their speciality. For example, entities 400 obtained from a search engine 110 that typically pertain predominantly to celebrity trivia could be tagged by associating a private tag 408 directly to network 11 address associated with the search engine 110. Thus, any searches for celebrity trivia would be directed to any search engines 110 tagged with the celebrity private tag 408. In this case, it is recognised that the search engines 110 could also be included in the entity table 109 along with their private tags 408, as desired. It is also recognised that the search engines 110 may be configured for Extranet searching (e.g. individual Internet Web sites) as well as for intranet searching (e.g. larger corporate sites).

### Update Module 412

Referring again to FIG. 5, the update module 412 is responsible for receiving the behavioural information 414 and for modifying the private tags 408 of the corresponding entities 400 in the entity table 109, as described by example above. For example, media entities 400 provided by the producers 102 (see FIG. 1), and suggested public tags 406 therefore, would initiate a tag 406 entry in the table 109. Based on monitored behavioural interaction with the tagged media entity 400 by the users 104, updates to the private tags 408 (and/or public tags 406) would be done. Also, based on popularity of certain noted entities 400, the update module 412 could decide to start monitoring behavioural interaction with the noted entities 400 and input corresponding tag entries into the table 109.

For example, in the case where the user 104 searched for other users as entities 400 (e.g. on-line dating), the private tags 408 of the other users would be modified by the update module 412. These updates would be based on the behavioural information 414 of the user 104 who initiated the search request 105 and/or tag cloud 502 content of the entities 400 in the search results 106. For example, the user 104 may have certain tags 405 (public and/or private) that would be used to update the private tags 408 of the user entity 400 found during a search. One example is where it is determined that the user A profile 504 indicates that they are from Europe (e.g. country public tag 406) and user A found user B through the search results 106. User A and user B then communicate through a series of instant messages or emails once user A contacts user B through the corresponding link 103 of the search results 106 (see FIG. 2). It is noted that the only other users 104 that user B corresponds with, once being initially contacted, are also from Europe. Hence, this behavioural information 414 (and/or noted in the tag clouds 502 of the other users 104) would be used to update the private tags 408 of user B as preferring to communicate with other users 104 from Europe.

A further example is where a particular user 104 decides to register with the media recommendation framework 108. The user 104 would provide their initial profile 504 through public tags 406. The update module 412 would then initiate a tag 405 entry in the table 109 for the particular user 104. Based on monitored behavioural information 414 and/or search results 106 of the particular user 104, updates to the private tags 408 of the particular user 104 would be done. These updates could be done on a periodic basis by first collecting of otherwise monitoring the behavioural information 414 and/or search results 106 pertaining to the user 104 over a period of time (e.g. predefined by the framework 108). Analysis of the collection of behavioural information 414 and/or search results 106 by the update module 412 would be used to generate new private tags 408 and thereby amend the tag 406,408 entries of the user 104 in the table 109. It is recognised that the monitoring of the behavioural information 414 could include receiving behavioural information 414 pertaining to registered users 104 from third party entities 415 external to the framework 108 (e.g. awards programs) and/or from analysis of the search requests 105 and interaction with the entities 400 in the search results 106 for registered users 104, as desired.

It is recognised that providing the registration information of the users 104 and/or producers 102 to the framework 108 can be done over the network 11. The communication of the registration information can include communication modes such as but not limited to: voice communication via phone; written communication via network messaging (e.g. email, facsimile); and/or others as desired.

It is recognised that the users 104 and/or the producers 102 registered with the framework 108 could be issued framework ID and password (optional), which uniquely identifies the particular user 104/producer 102. The framework ID could be associated with the tag entries in the table 109, thus facilitating updates of the public tags 406 by the users 104 and/or the producers 102 for corresponding entities 400. This can be accomplished by a registration module (e.g. an update module 412—see FIG. 5) in communication with the user 104 and/or producer 102, as desired.

Further, it is recognised that the update module 412 can use the behavioural information 414 known about non-registered entities 400 to create a profile 504 and corresponding tag cloud 502 for use by the framework 108, as desired. This creation of the tag cloud 502 for the non-registered entities 400 can be done during generation of the search result 106 or can be done after generation of the search result 106. Further, it is recognised that identification of the non-registered entities 400 present in the search results 106, obtained by the search module, can be used to initiate the registration of the identified non-registered entities 400 in the search results 106 (e.g. by noting that certain entities 400 in the search results 106 do not have a corresponding entity identifier 402 (see FIG. 4) stored in the memory 210. Registration of the non-registered entities 400 would be effected by creating a new profile 504 for them in the storage 210. It is also recognised that the update module 412 can be responsible for registering new users 104 and/or media entities 400 through the creation of the corresponding profile 504 in the storage 210 and assignment of the user/media identification and password as noted above.

### Operation of the System 10

### Operation of the Update Module 412

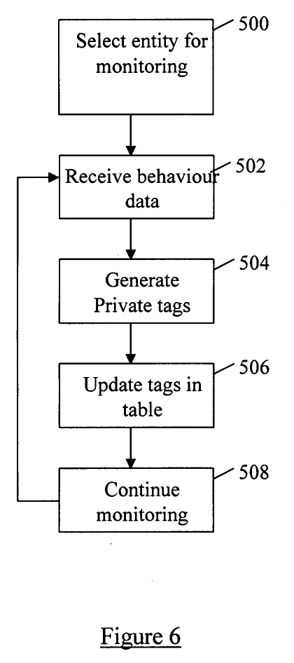

Referring to FIGS. 2, 5 and 6, shown is an example operation of the update module 412 for amending the private tags 408 (and/or public tags 406) of selected entities 400. At step 500 the module 412 selects at least one entity 400 for monitoring associated with that entity 400. For example, the selection process can be initiated through registration (having an assigned ID 402) of the user 104 and/or producer 102 with the framework 108. Also recognised is that particular search engines 110 can also register with the framework 108 (having an assigned ID 402) and thus have entities 400 of their search results tagged with private tags 408, as described above. At step 502, the module 412 receives the behavioural information 414 and/or search results 106 pertaining to the monitored entity 400.

This information 414 can come from third party sources 415. For example, the module 412 can collect behavioural information 414 from a number of different sources 415 and/or multiple search requests 105 and results 106 for a period of time, in order to facilitate recognition of certain behavioural patterns before beginning to generate corresponding private tags 408. It is recognised that the behavioural information 414 and/or search results 106 collected for one entity 400 may contain information that pertains to another entity 400, which may or may not be currently monitored by the framework 108. For example, the collection of behavioural information 414 and/or search results 106 for a monitored user 104 may contain information on interest in football related products, travel within the United States, purchase of sports tickets or otherwise attendance of sports games, and gift purchases for friends/family. Based on this collection, the corresponding private tags 408 would include any combination of tags 405 representative of travel with friends to U.S. cities having a football franchise.

At step 504, the private tags 408 are generated based on the collected behavioural information 414 and at step 506 the storage 210 is accessed in order to update the private tags 408 of the tag cloud 502 associated with the monitored entity 400. At step 508, the monitored entity 400 is selected for continued monitoring, i.e. any further behavioural information 414 and/or search results 106 received will be used for further consideration to update the private tags 408.

### Operation of the Framework 108

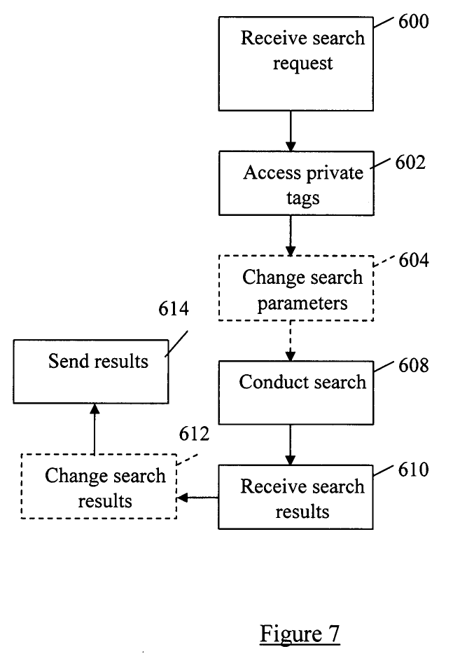

Referring to FIGS. 5 and 7, shown is an example operation of the framework 108 for providing search results 106 to a user 104. At step 600, the framework 108 receives the search request 105 from the user 104. It is recognised that the framework 108 is configured to receive and process multiple requests 105 from multiple users 104. At step 602, the private tags 408 of the user are accessed and at step 604, optionally, the search request parameters 99 are changed to incorporate those private tags 408 that are deemed by the module 407 to pertain to the subject matter of the search request parameters 99. At step 608, the module 410 facilitates the conduction of the search via the search engine 110. It is recognised that the particular search engine 110 may be selected from a group of available search engines based on the private 408 and/or public 406 tags of the user 104. At step 610, the search results 106 are received. At step 612, optionally, the search results 106 are modified in view of the private tags 408 of the user 104 that are deemed by the module 407 to pertain to the subject matter of the search request parameters 99. At step 614, the search results 106 are sent to the user 104.

It is recognised that in the above operations of the system 10, the entities 400 can be any of the types given by example. Accordingly, the system 10 provides for search results 106 that can include a variety of different entity types 404 based on the parameters of the search request 105,111 (see FIG. 5). It is recognised that the system can treat both users 104 and media similarly as entities 400 in the group 401 of available entities 400 for matching to the parameters 99 of the search requests 105 (see FIG. 1).

We claim:

1. An entity recommendation system for providing a search result in response to a search request of a user communicated over a communications network, the system comprising:
a storage for storing a plurality of profiles for a corresponding plurality of registered entities of different entity types, the plurality of profiles including the profile of the user when registered as one of the registered entities, each of the profiles including a profile parameter defining a characteristic of the respective registered entity and an entity identifier;
a receipt module configured for receiving the search request including an identity of the user and at least one search parameter;
a modification module configured for accessing the user profile in the storage based on the user identity matching the corresponding entity identifier and for generating a modified search request including the search parameter and the user profile parameter obtained from the user profile;
a search module configured for coordinating a search of a group of entities with corresponding mixed types of the different entity types for determining a plurality of entities matching the parameters of the modified search request, at least one of the matched entities having a corresponding entity profile stored in the storage;
a generator module configured for generating the search result as a list of the matched entities including said at least one of the matched entities having the entity profile stored in the storage; and
a transmit module configured for communicating the search result to the user over the network.

2. The system of claim 1, wherein the different entity types include a user type selected from the group comprising people and named organizations, and further includes a media type selected from the group comprising image files, video files, audio files, Web sites, electronic documents, online advertisements, blogs, and podcasts.

3. The system of claim 2 further comprising an update module for assigning the profile parameter to each of the profiles of the plurality of profiles in the storage.

4. The system of claim 3, wherein the profile parameter is a tag for providing the characteristic as entity information selected from the group comprising: the entity identifier; the entity type; a description of the entity; and a label of the entity.

5. The system of claim 4, wherein the tag is one of a plurality of tags of a tag cloud associated with the respective entity profile, the plurality of tags for providing a plurality of the profile parameters selected from the group comprising: a keyword; a term; and a phrase.

6. The system of claim 5, wherein the tag is defined using a structured definition language.

7. The system of claim 4, wherein the tag is selected from the group comprising: a public tag such that the user has access to knowledge of the details of the public tag; and a private tag such that access to knowledge of the details of the private tag is restricted.

8. The system of claim 5 further comprising the update module further configured for dynamically updating the user tags of the user profile based on entity tags of the entity profile of said at least one of the matched entities having the entity profile stored in the storage.

9. The system of claim 8, wherein the updated user tags are private tags of the user and the entity tags are public tags of said at least one of the matched entities, such that the user profile includes a tag window predefined for limiting the number of private tags included in the user profile.

10. The system of claim 9, wherein each of the private tags in the tag window has a ranking for use in deciding by the update module of the inclusion of each of the private tags in the tag window.

11. An entity recommendation method for providing a search result in response to a search request of a user communicated over a communications network, the method comprising the acts of:
storing a plurality of profiles for a corresponding plurality of registered entities of different entity types, the plurality of profiles including the profile of the user when registered as one of the registered entities, each of the profiles including a profile parameter defining a characteristic of the respective registered entity and an entity identifier;
receiving the search request including an identity of the user and at least one search parameter;
accessing the user profile in the storage based on the user identity matching the corresponding entity identifier;
generating a modified search request including the search parameter and the user profile parameter obtained from the user profile;
coordinating a search of a group of entities with corresponding mixed types of the different entity types for determining a plurality of entities matching the parameters of the modified search request, at least one of the matched entities having a corresponding entity profile stored in the storage;
generating the search result as a list of the matched entities including said at least one of the matched entities having the entity profile stored in the storage; and
communicating the search result to the user over the network.

12. The method of claim 11, wherein the different entity types include a user type selected from the group comprising people and named organizations, and further includes a media type selected from the group comprising image files, video files, audio files, Web sites, electronic documents, online advertisements, blogs, and podcasts.

13. The method of claim 12 further comprising the act of assigning the profile parameter to each of the profiles of the plurality of profiles in the storage.

14. The method of claim 13, wherein the profile parameter is a tag for providing the characteristic as entity information selected from the group comprising: the entity identifier; the entity type; a description of the entity; and a label of the entity.

15. The method of claim 14, wherein the tag is one of a plurality of tags of a tag cloud associated with the respective entity profile, the plurality of tags for providing a plurality of the profile parameters selected from the group comprising: a keyword; a term; and a phrase.

16. The method of claim 15 further comprising the act of defining using a structured definition language.

17. The method of claim 14, wherein the tag is selected from the group comprising: a public tag such that the user has access to knowledge of the details of the public tag; and a private tag such that access to knowledge of the details of the private tag is restricted.

18. The method of claim 15 further comprising the act of dynamically updating the user tags of the user profile based on entity tags of the entity profile of said at least one of the matched entities having the entity profile stored in the storage.

19. The method of claim 18, wherein the updated user tags are private tags of the user and the entity tags are public tags of said at least one of the matched entities, such that the user profile includes a tag window predefined for limiting the number of private tags included in the user profile.

20. The method of claim 19, wherein each of the private tags in the tag window has a ranking for use in deciding by the update module of the inclusion of each of the private tags in the tag window.
